(19) United States
(12) Patent Application Publication
(10) Pub. No.: US 2001/0025422 A1
(43) Pub. Date: Oct. 4, 2001

(54) Corner cutter

(76) Inventor: Mitsukazu Momosaki, Fukuoka (JP)

Correspondence Address: WEINGRAM & ASSOCIATES, P.C., P.O. BOX 927, 197 W. Spring Valley Avenue, Maywood, NJ, 07607, US

(21) Appl. No.: 09/765,960

(22) Filed: Jan. 19, 2001

(30) Foreign Application Priority Data
Jul. 24, 1998 (JP) H10-210059

(51) Int. Cl. B26B 17/00

(52) U.S. Cl. 30/178; 30/179; 30/193

(57) ABSTRACT

A cutting operation that is a finishing grinding pretreatment for a plate glass corner treatment is provided which includes, a construction such as the opening and closing of upper and lower blades cutting plate glass by the respective upper and lower blades. The upper and lower blade edge lines of the same upper and lower blades mutually opposing (each other) in the upper and lower blade edge section of a cutter body that is formed in an almost scissor shape; and the same upper and lower blade edge lines almost coincide to the planned cut line of the corner section of the plate glass.

### BACKGROUND OF THE INVENTION

This invention pertains to a corner cutter.

Previously, corner section treatments such as rounding off tangent sections of a sheet form brittle material 1, such as plate glass, that is shaped in a right angle, as shown in FIG. 7, were finished in a shape shown by planned finish line B1 by grinding operations, but cutting tools with upper and lower blade edges opposing (each other) and opening and closing, the so-called “chewing”, were used as a pretreatment of this grinding operation, and the section cut off from the edge of a sheet form brittle material 1 to a planned cut line C1 that was determined for the grinding material to remain outside of a planned finish line B1 had operations performed with bit-by-bit erosion.

Known operations with bit-by-bit cutout sections by the chewing in the pretreatment step prior to finishing operations had problems such as taking a lot of time and labor as well as requiring a fair amount of skill.

### SUMMARY OF THE PRESENT INVENTION

Thus, this invention offers a corner cutter that is characterized as being constructed by upper and lower blades being respectively established such as the upper and lower blade edge lines of the same upper and lower blades mutually opposing (each other) on the upper and lower blade edge section of a cutter main body in an almost scissor shape such as the opening and closing motion of the upper and lower blades cutting plate glass. Further, the same upper and lower blade edge lines almost coincide to a planned cut line of a plate glass corner section.

Also, there are the following characteristics added.

At least one end section of the upper and lower blade edge lines of the same upper and lower blades are constructed such as obtaining a position outside the plate glass in a condition where the upper and lower blades are closed.

The space between the end sections of the upper and lower blade edge lines is narrower than the space between the center section of the same upper and lower blade edge lines in a condition where the upper and lower blades are closed.

The center section of the above-mentioned upper and lower blade edge lines curves to the cutter body side.

The center section of the above-mentioned upper and lower blade edge lines curves to the reverse side of the cutter body.

Here, sheet form brittle materials are materials that are brittle and in a sheet form such as plate glass, mirrors, (bathroom) tiles and (roof) tiles.

### BRIEF DESCRIPTION OF THE DRAWINGS

FIG. 1 is a lateral view of a corner cutter pertaining to a first embodiment of the present invention.

FIG. 2 is a plan view thereof.

FIG. 3 is a front view thereof.

FIG. 4 is a cross-sectional lateral view of the upper and lower blades of the first embodiment.

FIG. 5 is a plan view showing utilization of a corner cutter of the first embodiment.

FIG. 6 is a front view showing utilization of a corner cutter of the first embodiment.

FIG. 7 is a plan view of a corner section of the first embodiment.

FIG. 8 is a lateral view of a corner cutter pertaining to a second embodiment of the present invention.

FIG. 9 is a plan view thereof.

FIG. 10 is a front view thereof.

FIG. 11 is a plan view showing utilization of a corner cutter of the second embodiment.

FIG. 12 is a lateral view showing utilization of a corner cutter of the second embodiment.

FIG. 13 is a plan view of a corner section of the second embodiment.

FIG. 14 is a lateral view of a guide of the present invention.

FIG. 15 is a plan view of the guide of the present invention.

FIG. 16 is a front view of the guide of the present invention.

### DESCRIPTION OF THE PREFERRED EMBODIMENTS

An actual embodiment of the invention is as follows.

Upper and lower blades which open and close and are mutually opposing (each other) are established on a blade edge section of a cutter body that is formed in an almost scissor shape, the upper and lower blade edge lines of the above-mentioned upper and lower blades almost coincide to a planned cut line of the plate glass, and the plate glass is such as that which is cut out being along a planned cut line.

Further, the upper and lower blade edge line is longer than the above-mentioned planned cut line and both edges of the same upper and lower blade edge line are such as obtaining a position outside the plate glass; and, the space between both end sections of the upper and lower blade edge lines of the same upper and lower blades is narrower than the space (between) the center sections of the same upper and lower blade edge lines; during the cutting operation, the distribution of the clamping pressure of the upper and lower blades to the plate glass is the greatest at the plate glass edge and gradually lessens relative to the approach to the center section, and the crack that is produced at the plate glass edge is such as running toward the center section along the upper and lower blade edge lines.

### EXAMPLES

Actual examples of the invention are explained by referring to the Figures.

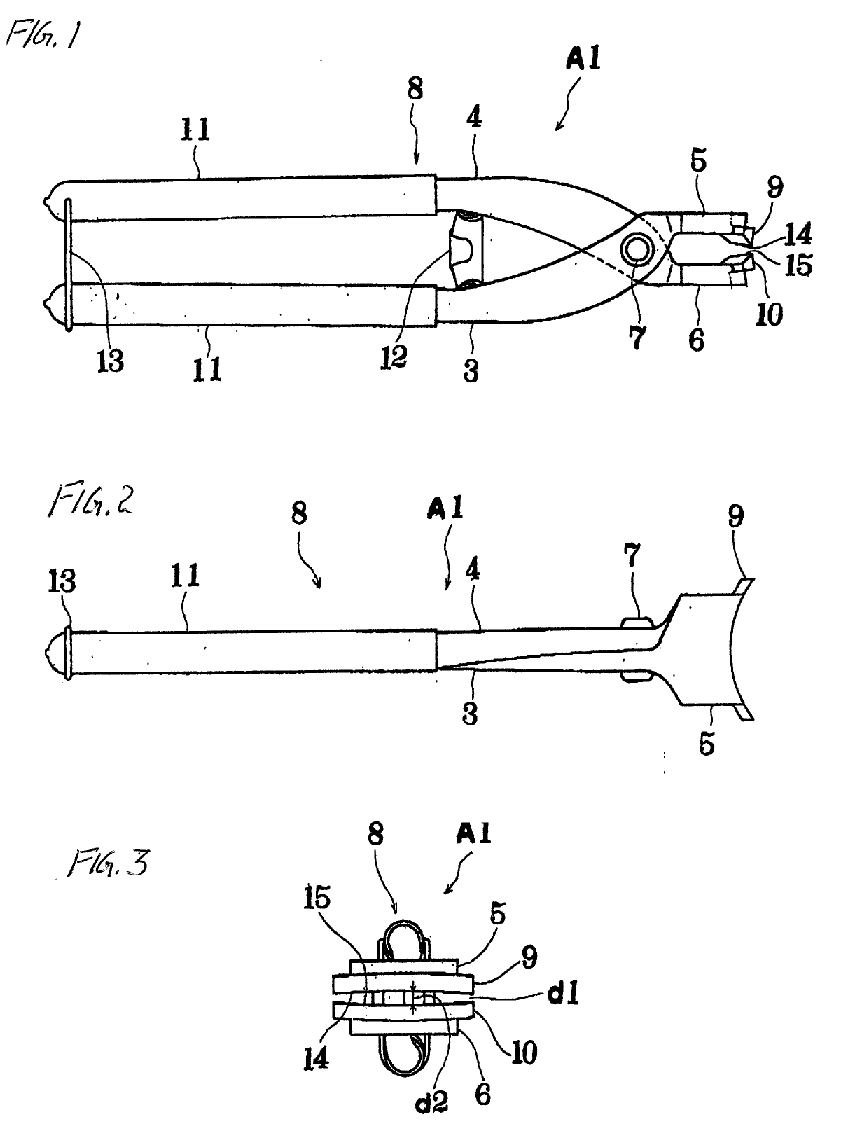

FIGS. 1-6 show the first Example of a corner cutter A1 pertaining to the present invention. This corner cutter A1 is one for shaping a corner section 2 of sheet form brittle material, such as plate glass 1, into an almost ¼ arch shape with the center section curving to the inside as shown in FIG. 7. The right handle section 3 and lower blade edge section 6 are formed as one unit and the left handle section 4 and upper blade edge section 5 are formed as one unit and (these units) are pivotally attached to swing freely by means of pivot 7. An almost scissor shaped cutter body 8 is formed and the upper and lower blades 9, 10 which are formed from ultra-hard metal alloys, are set in upper and lower blade edge sections 5, 6. In the Figures, 11 is a handle section cover, 12 is a return spring, and 13 is a stop that maintains cutter body 8 in an open condition.

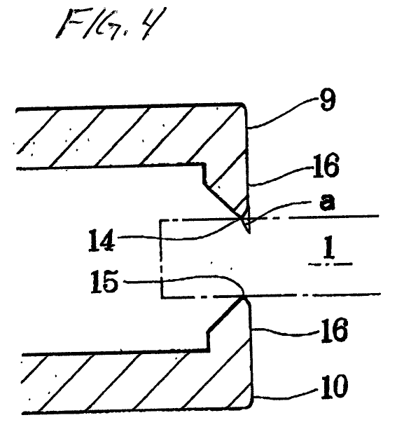

The upper and lower blade edge lines 14, 15 of upper and lower blades 9, 10 are formed in an almost ¼ arc shape and the center sections curve to the cutter body 8 side, as shown in the plan figures of FIG. 2 and FIG. 5 and, are formed such as coinciding with the below-mentioned planned cut line C1. Further, the space d1 of the upper and lower blade edge lines 14, 15 (between) the left and right two edges is narrower than the space d2 (between) the center sections of the upper and lower blade edge lines 14, 15 in the condition where the upper and lower blades are closed as shown in the front view of FIG. 3. Also, the upper and lower blade edge lines 14, 15 of the upper and lower blades 9, 10 edges are exactly opposite, as shown in the cross-sectional diagram of FIG. 4, and the plate glass 1 receives clamping pressure between the upper and lower blade edge lines 14, 15 by the opening and closing of the upper and lower blade edge sections 5, 6; the outside surface 16 of the upper and lower blades 9, 10 is formed to be perpendicular to plate glass 1, which is the object to be cut, and the inside surface only is formed as a single (blade) edge with a rake a.

The utilization method of a corner cutter A1 of the first Example is as in the following.

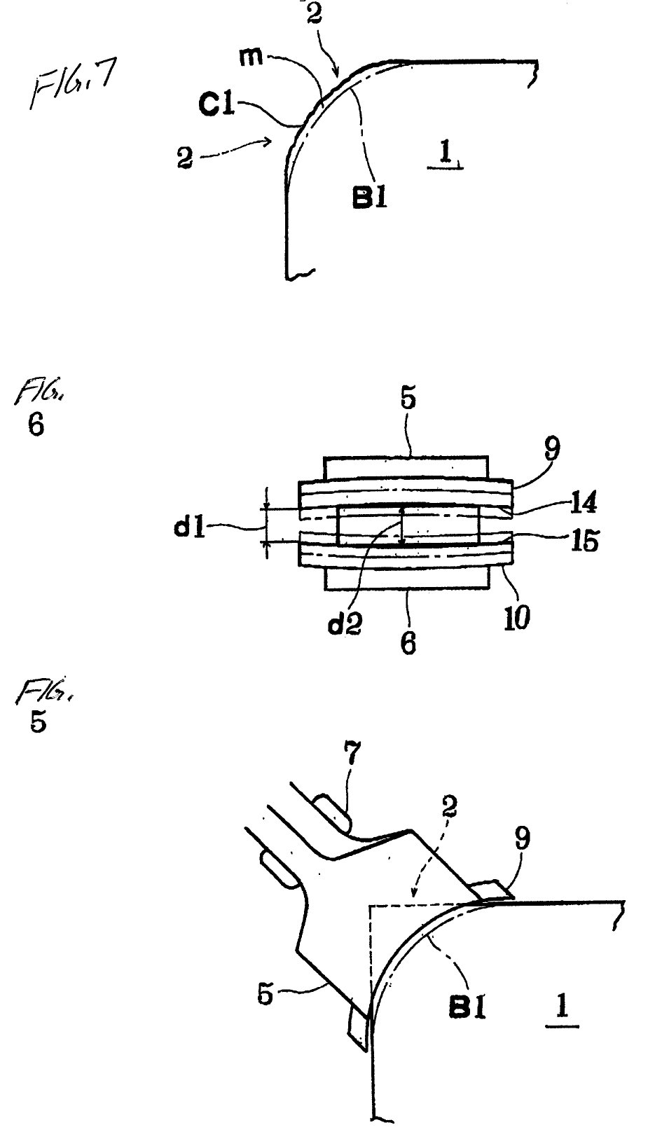

Planned cut line C1 is set by establishing the outside grinding material m of the same planned finish line B1 by marking off planned finish line B1 on a corner section 2 of plate glass 1 as shown in FIG. 5. The upper and lower blade edge lines 14, 15 conforms to the same planned cutting line C1, the right and left both edge sections of the same upper and lower blade edge lines 14, 15 are positioned outside the edge of plate glass 1. When upper and lower blade edge sections 5, 6 are closed by squeezing the right and left handles 4, 3, as shown in FIG. 6, the plate glass 1 is clamped between upper and lower blade edge lines 14, 15. But, as in the aforementioned, clamping pressure is produced in both directions where crossing orthogonally at the surface of plate glass 1 between the same upper and lower blade edge lines 14,15 since the upper and lower blade edge lines 14,15 are exactly opposite and the distribution of the clamping pressure is greatest at both edge sections of the plate glass 1 planned cut line C1 and gradually decreases relative to approaching the center section.

The crack which is produced in plate glass 1 is first produced at both edge sections of the planned cut line C1 of the plate glass 1 periphery where the clamping pressure is the greatest, then moves from that toward the center section of planned cut line C1, and divergences from planned cut line C1 are prevented by controlling the clamping pressure of the upper and lower blades 9, 10.

Further, a section outside planned cutting line C1 is crushed since a rake a is formed only at the inside surface of upper and lower blades 9, 10. The original form is maintained for the section inside planned cut line C1 and the forming of a corner section 2 in planned cut line C1 as shown in FIG. 7 is possible, since a crack along planned cut line C1 is produced in front of where this crushing occurs and crushing proceeding to inside beyond the same crack is prevented.

After the cutting operation is performed, the corner section 2 is ground and finished with performance to planned finish line B1 with items like a grinder or whetstone.

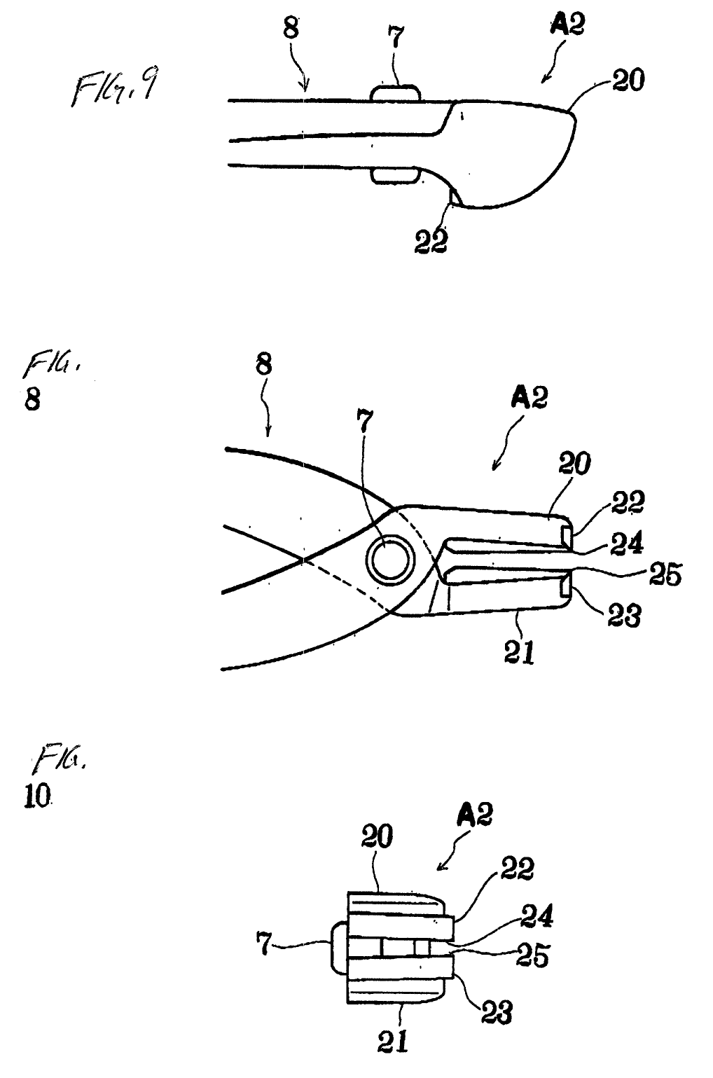

FIGS. 8-12 show a corner cutter A2 of a second Example; the corner section 2 of plate glass 1 is one that is cut along a planned finish line B2 of an almost ¼ arch shape with a center section that curves to the inside as shown in FIG. 13; planned cut line C2 establishes the grinding material m from the above-mentioned planned finish line B2, and is shaped in an almost ¼ arch shape with the center section curved to the inside.

Concretely, upper and lower blades 22, 23 curve in an almost ¼ arch shape outside the center section for upper and lower blade edge sections 20, 21 of cutter body 8 that is formed almost the same way as the aforementioned first Example; one of the end sections of the same upper and lower blades 22, 23 is parallel with the length of cutter body 8 and the other end section is positioned such as orthogonally crossing this.

Further, the above-mentioned upper and lower blades 22, 23 are mutually exactly opposite the upper and lower blade edge lines 24, 25 in the same way as the first Example, and the space (between) the upper and lower blade edge lines 24, 25 of the end sections of the side that is parallel to the length of the cutter body 8 is narrower than the space at the other end. Further, the rakes of the upper and lower blades 22, 23 are also established at only the side where there is cutting in the same way as the first Example.

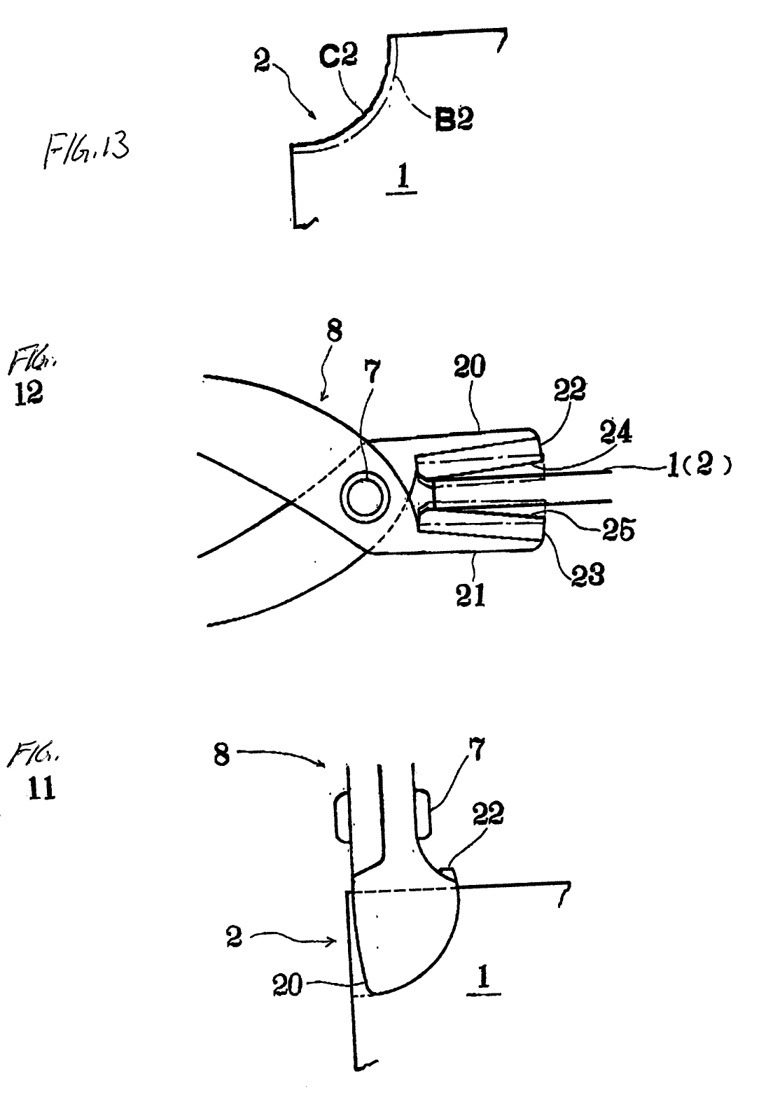

FIGS. 11 and 12 show utilization conditions of a second Example corner cutter A2. The end section of the side that is parallel to the length of the cutter body 8 of the upper and lower blade edge lines 24, 25 is positioned outside one edge of corner section 2 of plate glass 1 with a right angle formed; the other end is positioned near the other edge of corner section 2. First, a crack is produced in a position where the edge of the plate glass 1 and the upper and lower blade edge lines 24, 25 cross, this crack runs toward the other end section of the upper and lower blade edge lines 24, 25, and cutting of plate glass 1 along planned cut line C1 is possible when upper and lower blade edge sections 20, 21 are closed by squeezing the right and left handle sections 4, 3.

Further, the end section of the side that does not cross with the plate glass 1 edge of the aforementioned upper and lower blade end lines 24, 25 does not contact the other edge of plate glass 1, and a force which separates the cut-off section outside planned cut line C2 is produced due to the rake which is established on upper and lower blades 22, 23. This force directs the crack in the direction of the above-mentioned other edge and the crack is prevented from running toward the inside of planned finishing line B2.

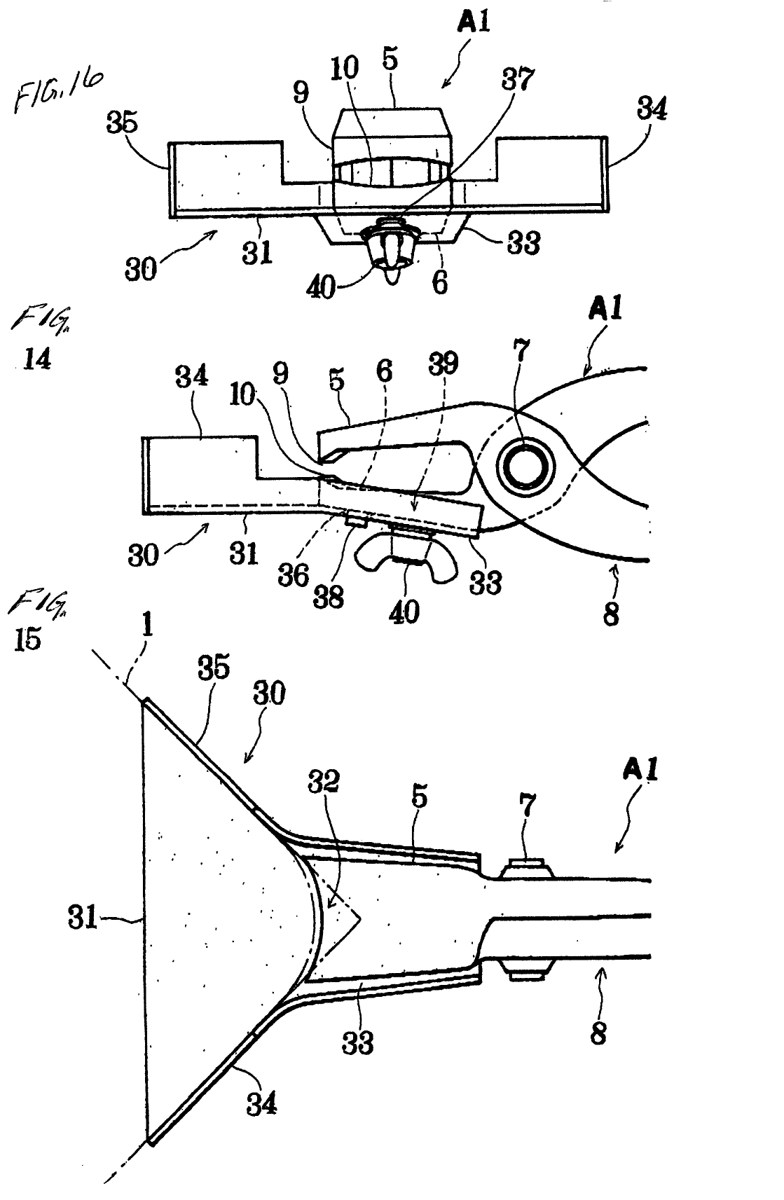

FIGS. 14-16 show a guide 30 for the simplification position determination of corner cutter A1 to plate glass 1 by being installed on a corner cutter A1 of the first Actual Example. Setting section 33 extends from the right angle peak section 32 of the almost right-angle isosceles triangle shaped bottom plate 31 in the direction of the cutter blade 8 and the periphery of the 2 sides which clamp the peak position the respective right and left guide plates 34, 35 which are situated on the right and left periphery of the setting section 33 for the same guide 30; and, position determining hole 36 and screw insertion hole 37 are formed in setting section 33.

Further, position determining projection 38 and female screw hole 39 are formed on the outside surface of the lower blade edge section 6 of cutter body 8; position determining projection 38 fits through position determining hole 36 of setting section 33 such as guide 30 being established on corner cutter A1 by means of a wing nut 40 which screws together and contracts through female screw hole 39 by insertion through screw insertion hole 37.

Thus, corner section 2 of plate glass 1 with a right angle formed is inserted between the right and left guide plates 34, 35, when the periphery of that same plate glass 1 abuts to the inside surface of the right and left guide plates 34, 35, the position of the upper and lower blade edge sections 5, 6 of corner cutter A1 is correct and efficient corner treatment operation can be performed which does not require things like marking-off, since (that) can be easily determined.

Further, a corner cutter of this invention is not limited to the above-mentioned cutting of plate glass, but can be widely utilized for materials that are in a sheet form and are brittle such as mirrors, (bathroom) tiles and (roof) tiles.

Effects such as the following can be obtained by the present invention.

The invention as described in claim 1 is constructed such as the opening and closing motions of upper and lower blades cutting plate glass due to the respective upper and lower blades being established such as the upper and lower blade edge lines of the same upper and lower blades mutually opposing (each other) in the upper and lower blade edge section of a cutter body that is formed in an almost scissor shape; further, a corner section of plate glass can be cut on a planned cut line by one opening and closing operation of the upper and lower blade edge sections and the efficiency of corner section treatment operations can be improved since the same upper and lower blade edge lines almost coincide at a planned cut line of a corner section of plate glass.

The invention as described in claim 2 can produce a crack with little clamping pressure by restricting the origin of a crack that is produced by the clamping pressure of the upper and lower blades to the plate glass periphery when a corner section is cut since the construction is such as positioning at least one end section of the upper and lower blade edge lines of the same upper and lower blades beyond the plate glass in a condition where the upper and lower blades are closed.

The invention as described in claim 3 has the distribution of the clamping pressure to the plate glass being greatest at the end section with the space of the upper and lower blade edge line being narrow and the direction in which the crack runs can be controlled while the crack can be prevented from going beyond the planned cut line since the space between the center sections of the upper and lower blade edge lines is narrower than the same upper and lower blade edge line center section in a condition where the upper and lower blades are closed.

The invention as described in claim 4 has the simple shaping of a corner section with a center section curving to the outside since the center sections of the above-mentioned upper and lower blade edge lines curve to the cutter body side.

The invention as described in claim 5 has the simple formation of a corner section with the curved section curving to the inside since the center sections of the above-mentioned upper and lower blade edge lines curve to the reverse side of the cutter body.

Explanation of the Symbols

A1—corner cutter

A2—corner cutter

1—plate glass (sheet form brittle material)

2—corner section

5, 6—upper and lower blade edge sections

8—cutter body

9, 10—upper and lower blades

14, 15—upper and lower blade edge lines

C1—planned cut line

It will be understood that the embodiments described herein are merely exemplary and that a person skilled in the art may make many variations and modifications without departing from the sphere and scope of the invention. All such variations and modifications are intended to be included in the scope of the invention as defined in the appended claims.

What is claimed is:

1. A corner cutter that is characterized by being constructed such as respective upper and lower blades being established with upper and lower blade edge lines of the same upper and lower blades mutually opposing each other on upper and lower blade edge sections of a cutter main body that is formed in an almost scissor shape and such as sheet form brittle materials being cut by the opening and closing motion of upper and lower blades, and, the same upper and lower blade edge lines almost coinciding to a planned cut line of corner section of a sheet form brittle material.

2. A corner cutter according to claim 1, that is characterized by being constructed with an end section of at least one side of upper and lower blade edge lines of the same upper and lower blades obtained as being positioned outside a sheet form brittle material in a situation where upper and lower blades are shut.

3. A corner cutter according to claim 1 or claim 2, that is characterized by a space between end sections of upper and lower blade edge lines of the same upper and lower blades being narrower than a space between the center sections of the same upper and lower blade edge lines in a situation where the upper and lower blades are closed.

4. A corner cutter according to claims 1-3, that is characterized by center sections of the above-mentioned upper and lower blade edge lines curving to a cutter main body side.

5. A corner cutter according to claims 1-3, that is characterized by center sections of the above-mentioned upper and lower blade edge lines curving to the reverse side of a cutter main body.
